(19) United States
(12) Patent Application Publication
(10) Pub. No.: US 2024/0250777 A1
(43) Pub. Date: Jul. 25, 2024

(54) Multi-Link Operation with Replicated Transmissions

(71) Applicant: TELEFONAKTIEBOLAGET LM ERICSSON (PUBL), Stockhom (SE)

(72) Inventors: Jonas SEDIN, Brentford (GB); Abhishek AMBEDE, Huddinge (SE); Miguel LOPEZ, Aachen (DE); Rocco DI TARANTO, LUND (SE); Leif WILHELMSSON, LUND (SE)

(21) Appl. No.: 18/560,522

(22) PCT Filed: May 19, 2021
(86) PCT No.: PCT/EP2021/063292

§ 371 Date: Nov. 13, 2023

(51) Int. Cl. H04L 1/08; H04L 1/1867; H04W 84/12

(52) U.S. Cl. CPC H04L 1/08; H04L 1/1896; H04W 84/12

(57) ABSTRACT

A wireless communication device (21) maintains a first wireless link and a second wireless link communicates, between the wireless communication device (21) and the further wireless communication device (22), an announcement of replicated transmissions of data on the first wireless link and the second wireless link. Further, the wireless communication device (21) sends the replicated transmissions (201, 202, 203) of the data on the first wireless link and the second wireless link.

### TECHNICAL FIELD

The present invention relates to methods for controlling wireless transmissions and to corresponding devices, systems, and computer programs.

### BACKGROUND

In wireless communication technologies, there is an increased interest in using unlicensed bands, like the 2.4 GHZ ISM (Industrial, Scientific and Medical) band, the 5 GHz band, the 6 GHz band, and the 60 GHz band using more advanced channel access technologies. Historically, WLAN (Wireless Local Area Network) technology based on the IEEE 802.11 standards family, also denoted as Wi-Fi, has been the dominant standard in unlicensed bands, specifically for applications requiring support for high data rates. The WLAN technology is specified in “IEEE Standard for Information technology—Telecommunications and information exchange between systems Local and metropolitan area networks—Specific requirements—Part 11: Wireless LAN Medium Access Control (MAC) and Physical Layer (PHY) Specifications,” IEEE Std 802.11-2016 (Revision of IEEE Std 802.11-2012), in the following also denoted as IEEE WLAN standard.

An enhancement of the WLAN technology referred to as EHT (Extremely High Throughput), to be introduced with an amendment denoted as IEEE 802.11be, is planned to introduce a feature denoted as ML (multi-link). Corresponding functionalities are for example described in IEEE draft “IEEE P802.11be/D0.1”, September 2020, in the following denoted as EHT draft amendment. In ML, a device termed as multi-link device (MLD) has multiple affiliated stations (STAs), each of which can communicate using independent wireless channels, also referred to as links. Communication over multiple links by an MLD is termed as multi-link operation (MLO). For example, an MLD can have two affiliated STAs, one communicating using a channel in the 5 GHz frequency band and the other communicating using a channel in the 6 GHz frequency band. Alternatively, as another example, an MLD can have two affiliated STAs, communicating using different channels in the 6 GHz frequency band.

An MLD can use its affiliated STAs and corresponding supported channels to perform simultaneous transmit (TX) MLO, simultaneous receive (RX) MLO, or simultaneous TX and RX (STR) MLO. This can help to improve the throughput and latency performance, as well as spectrum utilization. An MLD trying to perform STR MLO may face severe cross-channel self-interference (SI) problems due to leakage from its TX to RX channels. The cross-channel SI signal power in a RX channel can be orders of magnitude higher than the power of the desired signal, thereby affecting the reception and/or sensing ability of the RX chain.

If an MLD can handle the cross-channel SI problem and thus perform STR over a pair of channels, that pair of channels can be classified as STR. On the other hand, if transmitting over one channel results in inability to simultaneously receive over another channel, that pair of channels can be classified as non-STR (NSTR). In the EHT amendment, it is planned that an MLD shall announce its STR capability related to a pair of supported channels. Simultaneous TX and simultaneous RX MLOs over NSTR pair of channels typically require that the transmissions over the two channels are synchronized to some extent, e.g., in terms of time-alignment to prevent occurrence of STR situations cross-channel SI resulting therefrom. This may result in rather strict requirements while executing such MLOs. On the other hand, when using an STR pair of channels, there may be significantly less requirements. Depending on the STR capability of an MLD on an operational pair of channels, an MLD can be classified as an STR MLD or as an NSTR MLD.

Also, depending upon the supported level of functionality over multiple links, an MLD can support an enhanced multi-link single radio (EMLSR) mode of operation or an enhanced multi-link multi-radio (EMLMR) mode of operation. In the EMLSR mode, an MLD can perform normal TX/RX on one link, while having reduced functionality, e.g., limited reception or channel sensing, on other links. In the EMLMR mode, an MLD can switch between multi-link and single link operations by reconfiguring usage of its radio chains, e.g., with respect to utilized MIMO (multiple input multiple output) configuration. For example, an MLD can switch between performing 4×4 MIMO on one link to performing 2×2 MIMO on two different links.

In the context of MLO, an MLD with two or more affiliated access point (AP) STAs, i.e., an MLD having AP functionalities on its channels, may be denoted as an AP MLD. An MLD with two or more affiliated non-AP STAs can in turn be referred to as a non-AP MLD. An AP MLD can perform simultaneous downlink (DL) MLO or simultaneous uplink (UL) MLO in cooperation with non-AP STAs. Additionally, an AP MLD that can perform STR MLO over two channels can also perform simultaneous DL and UL MLO, with the possibility of independently transmitting and receiving various types of frames over its channels.

In the WLAN technology, it is also known to utilize a technique denoted as frame replication. Frame replication may be applied to increase reliability in use cases where reliability and low latency are important. Frame replication typically involves that data conveyed in a frame is transmitted multiple times on higher protocol layers, e.g., above the MAC (Medium Access Control) layer, to increase the likelihood of the data being successfully received. A receiver may then perform duplicate detection to eliminate any duplicated data so that the end user only receives one copy of the data.

In the WLAN technology, duplications of frames may arise when frames are retransmitted based on acknowledgement (ACK) feedback. According to the IEEE WLAN standard, duplicate frame detection may be based on a Retry bit of a Frame Control field and a Sequence Control field of a Data, Management or Extension frame. The Sequence Control field includes a sequence number and a fragment number. The Retry bit is set on any frame that is retransmitted. Duplicate frame detection may be performed by the receiver device keeping track of the sequence numbers and fragment numbers of the frames received in the current acknowledgement window. Duplicated transmissions due to retransmissions would thus only occur within the acknowledgement window. Further, duplicate frame detection can only be performed after successfully decoding a received protocol packet data unit (PPDU).

Further, in the IEEE WLAN standard frame replication may be supported by allowing proprietary scheduling of data in a sequential manner, so that multiple sequential transmissions of the same data are scheduled, irrespective of any acknowledgement feedback. However, such sequential replication may be rather resource-intensive in terms of time-frequency resources and in terms of required supply power, potentially increases latency, and may result in an increase in implementation complexity. In “RTA Optimization proposal Sep Kona Meeting”, Internet document IEEE 802.11-18/1543r4 (URL: “https://mentor.ieee.org/802.11/dcn/18/11-18-1543-04-0000-rta-dual-link-proposal.pptx”, December 2018) proposes replicated transmissions of real-time gaming traffic based on concurrent dual link transmission over a 2.4 GHz link and a 5 GHz link.

However, usage of currently available techniques to perform replicated transmissions over two links is not straightforward and may result in a lack of efficiency and other issues. For example, such techniques may result in a requirement that the receiver MLD attempts to fully receive the replicated transmissions over both links. Further, if the receiver is a NSTR MLD, it may be required to perform end-time alignment of the replicated transmissions, to ensure that the NSTR MLD does not have to perform simultaneous transmission and reception. Further, if the receiver is an NSTR MLD, it may not be allowed to transmit an ACK on one link during ongoing reception on the other link to prevent cross-channel SI.

Accordingly, there is a need for techniques which allow for controlling replicated transmissions in MLO.

### SUMMARY

According to an embodiment, a method of controlling wireless transmissions in a wireless communication system is provided. According to the method, a wireless communication device maintains a first wireless link and a second wireless link to a further wireless communication device. Further, the wireless communication device communicates, between the wireless communication device and the further wireless communication device, an announcement of replicated transmissions of data on the first wireless link and the second wireless link. Further, the wireless communication device sends the replicated transmissions of the data on the first wireless link and the second wireless link.

According to a further embodiment, a wireless communication device for operation in a wireless communication system is provided. The wireless communication device is configured to maintain a first wireless link and a second wireless link to a further wireless communication device. Further, the wireless communication device is configured to communicate, between the wireless communication device and the further wireless communication device, an announcement of replicated transmissions of data on the first wireless link and the second wireless link. Further, the wireless communication device is configured to send the replicated transmissions of the data on the first wireless link and the second wireless link.

According to a further embodiment, a wireless communication device for operation in a wireless communication system is provided. The wireless communication device comprises at least one processor and a memory. The memory contains instructions executable by said at least one processor, whereby the wireless communication device is operative to maintain a first wireless link and a second wireless link to a further wireless communication device. Further, the memory contains instructions executable by said at least one processor, whereby the wireless communication device is operative to communicate, between the wireless communication device and the further wireless communication device, an announcement of replicated transmissions of data on the first wireless link and the second wireless link. Further, the memory contains instructions executable by said at least one processor, whereby the wireless communication device is operative to send the replicated transmissions of the data on the first wireless link and the second wireless link.

According to a further embodiment, a method of controlling wireless transmissions in a wireless communication system is provided. According to the method, a wireless communication device maintains a first wireless link and a second wireless link to a further wireless communication device. Further, the wireless communication device communicates, between the wireless communication device and the further wireless communication device, an announcement of replicated transmissions of data on the first wireless link and the second wireless link. Further, the wireless communication device receives at least one of the replicated transmissions of data.

According to a further embodiment, a wireless communication device for operation in a wireless communication system is provided. The wireless communication device is configured to maintain a first wireless link and a second wireless link to a further wireless communication device. Further, the wireless communication device is configured to communicate, between the wireless communication device and the further wireless communication device, an announcement of replicated transmissions of data on the first wireless link and the second wireless link. Further, the wireless communication device is configured to receive at least one of the replicated transmissions of the data.

According to a further embodiment, a wireless communication device for operation in a wireless communication system is provided. The wireless communication device comprises at least one processor and a memory. The memory contains instructions executable by said at least one processor, whereby the wireless communication device is operative to maintain a first wireless link and a second wireless link to a further wireless communication device. Further, the memory contains instructions executable by said at least one processor, whereby the wireless communication device is operative to communicate, between the wireless communication device and the further wireless communication device, an announcement of replicated transmissions of data on the first wireless link and the second wireless link. Further, the memory contains instructions executable by said at least one processor, whereby the wireless communication device is operative to receive at least one of the replicated transmissions of the data.

According to a further embodiment, a computer program or computer program product is provided, e.g., in the form of a non-transitory storage medium, which comprises program code to be executed by at least one processor of a wireless communication device for a wireless communication system. Execution of the program code causes the wireless communication device to maintain a first wireless link and a second wireless link to a further wireless communication device. Further, execution of the program code causes the wireless communication device to communicate, between the wireless communication device and the further wireless communication device, an announcement of replicated transmissions of data on the first wireless link and the second wireless link. Further, execution of the program code causes the wireless communication device to send the replicated transmissions of the data on the first wireless link and the second wireless link.

According to a further embodiment, a computer program or computer program product is provided, e.g., in the form of a non-transitory storage medium, which comprises program code to be executed by at least one processor of a wireless communication device for a wireless communication system. Execution of the program code causes the wireless communication device to maintain a first wireless link and a second wireless link to a further wireless communication device. Further, execution of the program code causes the wireless communication device to communicate, between the wireless communication device and the further wireless communication device, an announcement of replicated transmissions of data on the first wireless link and the second wireless link. Further, execution of the program code causes the wireless communication device to receive at least one of the replicated transmissions of the data.

Details of such embodiments and further embodiments will be apparent from the following detailed description of embodiments.

### BRIEF DESCRIPTION OF THE DRAWINGS

FIG. 1 schematically illustrates a wireless communication system according to an embodiment.

FIG. 2A schematically illustrates an example of processes involving multi-link replicated transmissions according to an embodiment.

FIG. 2B schematically illustrates an example of an announcement of multi-link replicated transmissions according to an embodiment.

FIG. 2C schematically illustrates a further example of an announcement of multi-link replicated transmissions according to an embodiment.

FIG. 3 schematically illustrates a further example of processes involving multi-link replicated transmissions according to an embodiment.

FIG. 4 schematically illustrates a further example of processes involving multi-link replicated transmissions according to an embodiment.

FIGS. 5A, 5B, and 5C illustrate exemplary sequences of transmissions based on multi-link replication according to an embodiment.

FIGS. 6A, 6B, and 6C illustrate possible time alignment configurations for multi-link replicated transmissions according to an embodiment.

FIG. 7 shows an example for illustrating termination of multi-link replicated transmissions according to an embodiment.

FIG. 8 shows a flowchart for schematically illustrating a method according to an embodiment.

FIG. 9 shows a block diagram for schematically illustrating functionalities of a wireless communication device according to an embodiment.

FIG. 10 shows a flowchart for schematically illustrating a further method according to an embodiment.

FIG. 11 shows a block diagram for schematically illustrating functionalities of a further wireless communication device according to an embodiment.

FIG. 12 schematically illustrates structures of a wireless communication device according to an embodiment.

### DETAILED DESCRIPTION

In the following, concepts in accordance with exemplary embodiments of the invention will be explained in more detail and with reference to the accompanying drawings. The illustrated embodiments relate to controlling of wireless transmissions in a wireless communication system. The wireless communication system may be a WLAN (Wireless Local Area Network) system based on a IEEE 802.11 technology. In accordance with the WLAN terminology, the wireless transmissions may also be referred to as “frames”. However, it is noted that the illustrated concepts could also be applied to other wireless communication technologies, e.g., to contention-based modes of the LTE (Long Term Evolution) or NR (New Radio) technology specified by 3GPP (3^{rd} Generation Partnership Project).

In the illustrated concepts replicated transmissions between wireless communication devices between are performed on multiple wireless links, i.e., based on multi-link operation (MLO). This mode of operation is in the following also denoted as multi-link (ML) replication. These wireless communication devices may correspond to various types of MLD. For example, the transmitter of the replicated transmissions could be a non-AP STA, and the receiver of the replicated transmissions an AP. Further, the transmitter of the replicated transmissions could be an AP, and the receiver of the replicated transmissions a non-AP STA. Still further, the transmitter and the receiver of the replicated transmissions could be a non-AP STA. In the illustrated concepts, the usage of replication for transmissions on the multiple wireless links is announced between the receiver and the transmitter. In the following, the announcement of the ML replication is also referred to as “replication indication” (RI). The announcement may be transmitted in various ways, e.g., in a Physical Layer (PHY) header, in a Medium Access Control (MAC) header, in a Request-to-Send (RTS) control frame, or in a trigger frame (TF). Based on the announcement, the transmitter and/or the receiver may adjust their operation in relation to the replicated transmissions, e.g., by skipping decoding of replicated data, ending an ongoing transmission of replicated data to reduce network resource usage, and/or overriding NSTR transmission rules.

The MLO may be based on ML functionalities of the EHT technology according to the IEEE 802.11be amendment. In these ML functionalities, an MLD is considered to have multiple affiliated STAs, each of which can communicate using independent wireless channels or links. For example, an MLD can have two affiliated STAs, one operating using one or more channels in the 5 GHz frequency band and the other operating using one or more channels in the 6 GHZ frequency band. According to another example, an MLD can have two affiliated STAs, each operating using channels in the 6 GHz frequency band. As used herein, a device capable of performing MLO is considered to be an MLD. An AP capable of performing MLO is considered to be an AP MLD. A non-AP device capable of performing MLO is considered to be a non-AP MLD. An MLD can use its affiliated STAs and corresponding supported channels to perform simultaneous TX MLO, simultaneous RX MLO, or STR MLO. If a TX operation on one channel results in inability to perform RX operation on another channel, that pair of channels can be classified as NSTR, and these channels can be used in NSTR MLO.

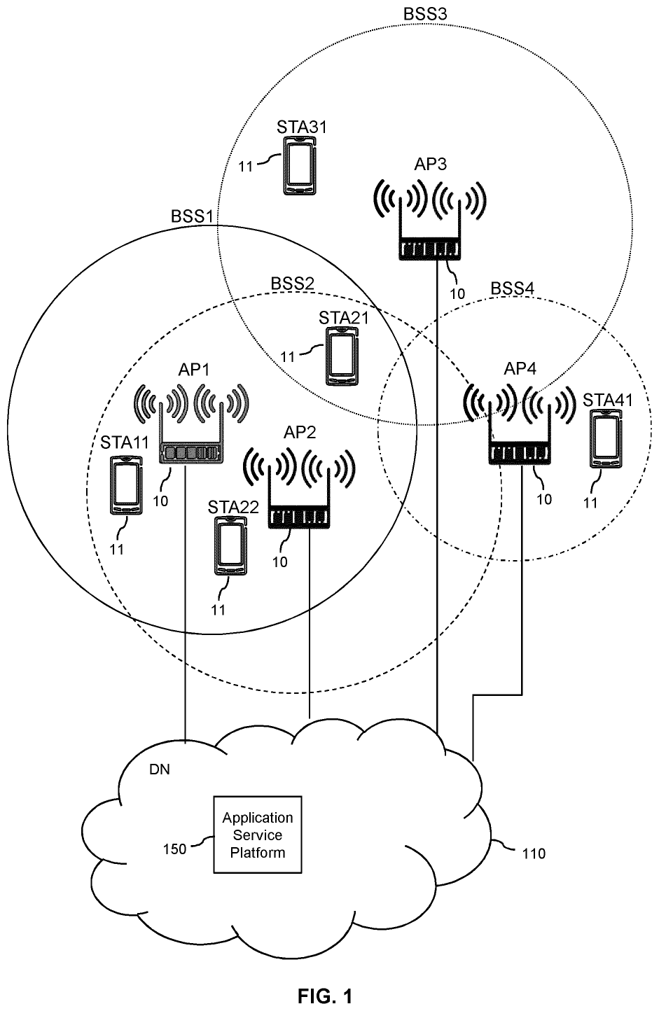

FIG. 1 illustrates an exemplary wireless communication system in which the illustrated concepts may be implemented. In the illustrated example, the wireless communication system includes multiple access points (APs) 10, in the illustrated example referred to as AP1, AP2, AP3, AP4, and multiple stations (STAs) 11, in the illustrated example referred to as STA11, STA21, STA22, STA31, and STA41. The station STA11 is served by AP1, in a first BSS (Basic Service Set) denoted as BSS1, the stations STA21 and STA22 are served by AP2, in a second BSS denoted as BSS2. The station STA31 is served by AP3, in a third BSS denoted as BSS3. The station STA41 is served by AP4, in a fourth BSS denoted as BSS4. The stations 11 may correspond to various kinds of wireless devices, for example user terminals, such as mobile or stationary computing devices like smartphones, laptop computers, desktop computers, tablet computers, gaming devices, or the like. Further, the stations 11 could for example correspond to other kinds of equipment like smart home devices, printers, multimedia devices, data storage devices, or the like.

In the example of FIG. 1, each of the stations 11 may connect through a radio link to one of the APs 10. For example depending on location or channel conditions experienced by a given station 11, the station 11 may select an appropriate AP 10 and BSS for establishing the radio link. The radio link may be based on one or more OFDM carriers from a frequency spectrum which is shared on the basis of a contention based mechanism, e.g., an unlicensed band like the 2.4 GHz ISM band, the 5 GHz band, the 6 GHz band, or the 60 GHz band. Some of the stations 11 may support MLO, i.e., may be MLDs.

Each AP 10 may provide data connectivity of the stations 11 connected to the AP 10. As further illustrated, the APs 10 may be connected to a data network (DN) 110. In this way, the APs 10 may also provide data connectivity of stations 11 connected to different APs 10. Further, the APs 10 may also provide data connectivity of the stations 11 to other entities, e.g., to one or more servers, service providers, data sources, data sinks, user terminals, or the like. Accordingly, the radio link established between a given station 11 and its serving AP 10 may be used for providing various kinds of services to the station 11, e.g., a voice service, a multimedia service, or other data service. Such services may be based on applications which are executed on the station 11 and/or on a device linked to the station 11. By way of example, FIG. 1 illustrates an application service platform 150 provided in the DN 110. The application(s) executed on the station 11 and/or on one or more other devices linked to the station 11 may use the radio link for data communication with one or more other stations 11 and/or the application service platform 150, thereby enabling utilization of the corresponding service(s) at the station 11.

In the system of FIG. 1, one or more of the APs 10 and/or STAs 11 are assumed to be MLDs which can operate as outlined above by performing replicated transmissions based on MLO. For example, in the system of FIG. 1, AP2 and STA21 could perform ML replication of transmissions in response to communicating an announcement of the ML replication.

Based on the announcement of the ML replication, the receiver MLD and/or the transmitter MLD may adapt its operation in relation to the replicated transmissions. This adaptation may for example allow for energy saving or improved efficiency of spectrum usage. Based on the RI, which notifies usage of replication in advance, the receiver MLD may for example be aware that a certain transmission is a replicated transmission, without requiring that the receiver MLD completely receives or decodes the received transmission, and for example checks sequence numbers, frame numbers, retry bits, or the like.

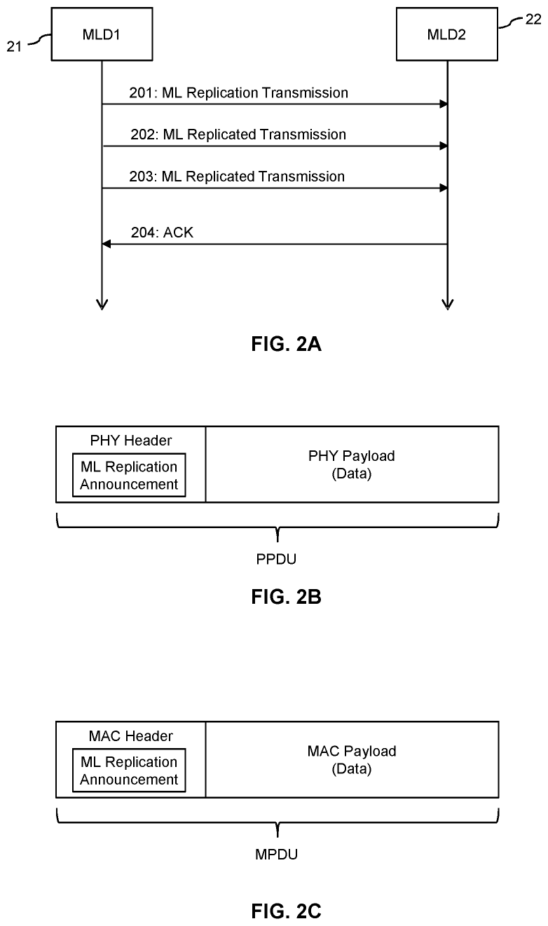

FIG. 2A schematically illustrates an example of processes involving ML replication in accordance with the illustrated concepts. The processes of FIG. 2A involve a first MLD (MLD1) 21, which acts as a transmitter of the replicated transmissions, and a second MLD (MLD2) 22, which acts as a receiver of the replicated transmissions.

As illustrated, the first MLD 21 sends multiple replicated transmissions, in the figure denoted as ML replication transmissions 201, 202, 203, to the second MLD 22. The replicated transmissions 201, 202, 203 are sent on multiple wireless links between the first MLD 21 and the second MLD 22. For the sake of simplicity, it is assumed that the number of the wireless links is two, so that at least one of the replicated transmissions 201, 202, 203 is sent on a first wireless link and at least one of the replicated transmissions 201, 202, 203 is sent on a second wireless link. However, it is noted that higher numbers of wireless links could be used in a corresponding manner. As further illustrated, in response to successfully receiving at least one of the replicated transmissions, the second MLD 22 may send an acknowledgement (ACK) 204 to the first MLD 21. The ACK 204 may be sent on one of the wireless links used for sending the replicated transmissions 201, 202, 203.

In the example of FIG. 2A, the announcement of the ML replication may be transmitted in a protocol header of the replicated transmissions, so that the second MLD 22 is aware of usage of ML replication for the received transmission without requiring decoding of a payload part of the received transmission. According to an example illustrated in FIG. 2B, the announcement of the ML replication is included in a PHY header of a PHY Protocol Data Unit (PPDU). According to an example illustrated in FIG. 2C, the announcement of the ML replication is included in a MAC header of a MAC Protocol Data Unit (MPDU). The announcement of the ML replication may for example be provided in a corresponding field of the PHY header or MAC header and may consist of one or more bits. It is noted that providing the announcement of the ML replication in the PHY header may allow for informing the second MLD 22 slightly earlier than in the case of providing the announcement of the ML replication in the MAC header, because announcement can for example be embedded inside a PHY preamble portion of the PHY header and thus at the very beginning of the transmission.

In some scenarios, the announcement of the ML replication may be included in each replicated transmission, e.g., in the PHY or MAC header of each of the transmissions 201, 202, 203. In other scenarios, the announcement of the ML replication could be provided in only some or even only one of the replicated transmissions, in particular the replicated transmission being sent first. For example, in the WLAN technology, it is known to aggregate MPDUs. The aggregation may happen in several ways, and there are typically restrictions imposed on the types of MPDUs that can be aggregated. In scenarios where the replicated transmissions include aggregated MPDUs, the announcement of the ML replication could be included in the MAC header of the first MPDU of a set of aggregated MPDUs.

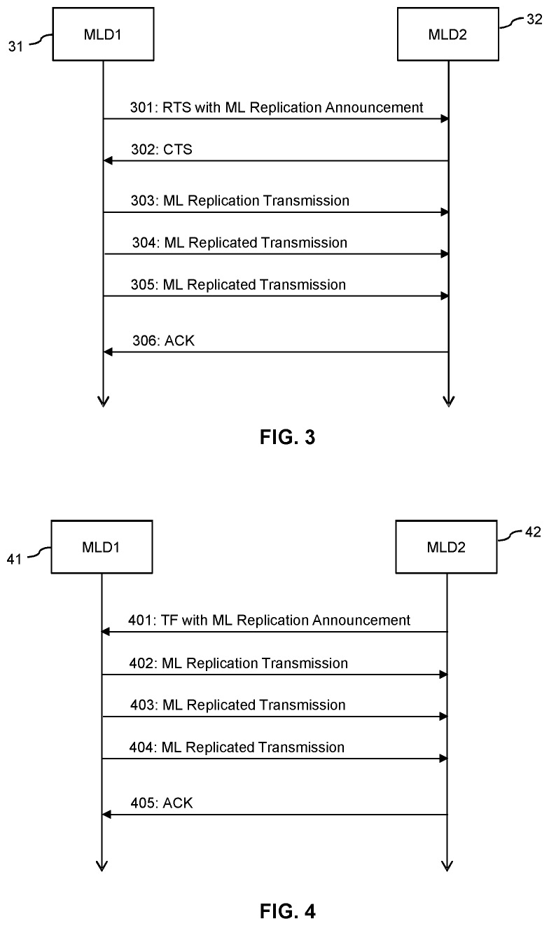

FIG. 3 shows a further example of processes involving ML replication in accordance with the illustrated concepts. The processes of FIG. 3 involve a first MLD (MLD1) 31, which acts as a transmitter of the replicated transmissions, and a second MLD (MLD2) 32, which acts as a receiver of the replicated transmissions.

As illustrated, the first MLD 31 sends a RTS message 301 to the second MLD 32. By means of the RTS message, the first MLD 31 indicates that it intends to transmit on the wireless medium. In this example, the RTS message 301 further includes the announcement of the ML replication, e.g., in a corresponding field of the RTS message 301. In response to the RTS message 301, the second MLD 32 sends a Clear-to-Send (CTS) message 302 to the first MLD 31, thereby confirming that, from perspective of the second MLD 32, the wireless medium is free to be used by the first MLD 31. Here, it is noted that the RTS message 301 and CTS message 302 may be transmitted on each of multiple wireless links between the first MLD 31 and the second MLD 32, or on only a subset of one or more of such wireless links. Transmitting the RTS message 301 and the CTS message 302 on only a subset of the wireless links may in some scenarios help to accommodate certain limitations, e.g., a limitation that a RTS messages transmitted to a MLD over a NSTR pair of wireless links need to be aligned in time.

In response to receiving the CTS message 302, the first MLD 31 sends multiple replicated transmissions, in the figure denoted as ML replication transmissions 303, 304, 305, to the second MLD 32. The replicated transmissions 303, 304, 305 are sent on the multiple wireless links between the first MLD 31 and the second MLD 32. For the sake of simplicity, it is assumed that the number of the wireless links is two, so that at least one of the replicated transmissions 303, 304, 305 is sent on a first wireless link and at least one of the replicated transmissions 303, 304, 305 is sent on a second wireless link. However, it is noted that higher numbers of wireless links could be used in a corresponding manner. As further illustrated, in response to successfully receiving at least one of the replicated transmissions, the second MLD 32 may send an ACK 306 to the first MLD 31. The ACK 306 may be sent on one of the wireless links used for sending the replicated transmissions 303, 304, 305.

FIG. 4 shows a further example of processes involving ML replication in accordance with the illustrated concepts. The processes of FIG. 4 involve a first MLD (MLD1) 41, which acts as a transmitter of the replicated transmissions, and a second MLD (MLD2) 42, which acts as a receiver of the replicated transmissions.

As illustrated, the second MLD 42 sends a trigger frame (TF) 401 to the first MLD 41. By means of the TF 401, the second MLD 42 triggers sending of transmissions by the first MLD 41. Such triggering of transmissions may for example be used if the second MLD 42 is an AP which reserved resources the wireless medium and coordinates usage of the reserved resources by other devices, in particular the first MLD 41. Such coordinated usage of reserved resources may for example be based on UL OFDMA (Uplink Orthogonal Frequency Division Multiple Access). The first MLD 41 could then for example be a STA associated with the AP formed by the second MLD 42. In a further example, the first MLD 41 could be another AP which cooperates through resource sharing with the AP formed by the second MLD 42. In the example of FIG. 4, the TF 401 further includes the announcement of the ML replication, e.g., in a corresponding field of the TF 401. It is noted that the TF 401 may be transmitted on each of multiple wireless links between the first MLD 41 and the second MLD 42, or on only a subset of one or more of such wireless links.

Sending the announcement of the ML replication in a TF can for example be beneficial if an AP MLD performs UL OFDMA on a channel with a lot of bandwidth in one frequency band, e.g., the 6 GHz band, and wants to ensure reliability by also replicating a transmission on a different channel in another frequency band with better performance, e.g., in the 2.4 GHz band. The replication in the other frequency band does not necessarily need to be performed based on UL OFDMA coordination by the AP MLD. It is noted that in the example of FIG. 4, the announcement of the ML replication is transmitted in an opposite direction as compared to the examples of FIGS. 2A and 3, namely from the receiver MLD to the transmitter MLD. In this way, the receiver MLD can itself orchestrate and thus prepare for the replicated transmissions.

In response to the TF 401, the first MLD 41 sends multiple replicated transmissions, in the figure denoted as ML replication transmissions 402, 403, 404, to the second MLD 42. The replicated transmissions 402, 403, 404 are sent on the multiple wireless links between the first MLD 41 and the second MLD 42. For the sake of simplicity, it is assumed that the number of the wireless links is two, so that at least one of the replicated transmissions 402, 403, 404 is sent on a first wireless link and at least one of the replicated transmissions 402, 403, 404 is sent on a second wireless link. However, it is noted that higher numbers of wireless links could be used in a corresponding manner. As further illustrated, in response to successfully receiving at least one of the replicated transmissions, the second MLD 42 may send an ACK 405 to the first MLD 41. The ACK 405 may be sent on one of the wireless links used for sending the replicated transmissions 402, 403, 404.

In a modification of the processes of FIG. 4, the TF 401 could be replaced by some other message used by the receiver MLD to request usage of ML replication by the transmitter MLD. Such request could then involve that, if the transmitter MLD can reserve the wireless medium on the corresponding link(s), it will send replicated transmissions on the corresponding link(s). In some cases, the receiver MLD could use a subset of one or more of the wireless links between the transmitter MLD and the receiver MLD to request usage of ML replication by the transmitter MLD on a specific set of one or more of the wireless links. The specific set could be indicated in the request message.

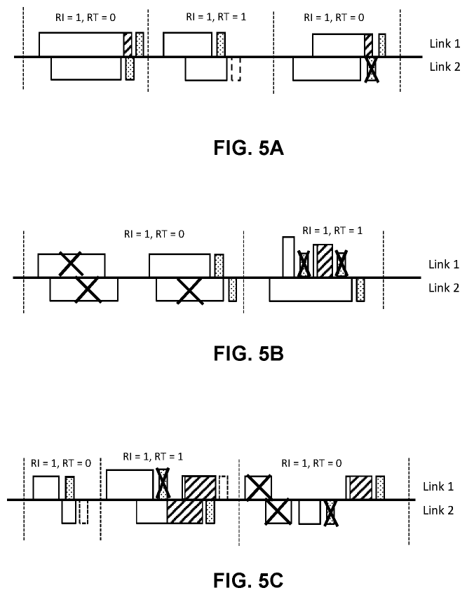

In order to differentiate between different instances of replicated transmissions over the multiple wireless links, a replication toggle (RT) indicator may be used, in the following also denoted as RT. The RT indicator may be a one bit field, e.g., in the MAC header of an MPDU, that indicates to the receiver MLD, e.g., to the second MLD 22, 32, or 42, whether the received replicated transmission is from a new set of replicated transmissions or not. FIGS. 5A, 5B, and 5C show examples of illustrating usage of such RT indicator, again assuming replicated transmissions on two wireless links, denoted as “link 1” and “link 2”. In these examples, the RT indicator is toggled by the transmitter MLD either upon successful reception of an ACK or after a pre-configured number of retransmission attempts. In these examples, each open box illustrates a replicated transmission from the transmitter MLD to the receiver MLD. A shaded box illustrates transmission of an ACK from the receiver MLD to the transmitter MLD. A cross-hatched area illustrates a part of a transmission where the receiver MLD stops decoding on one link, because a corresponding replicated transmission was already successfully received on the same link or on the other link.

In the example of FIG. 5A, the transmitter MLD sends replicated transmissions on both links. For these replicated transmissions RI is set to 1 and RT is set to 0. The replicated transmission on link 2 is finished first and successfully received by the receiver MLD, while the replicated transmission on link 1 still continues. The receiver MLD thus sends an ACK on the second link and stops decoding the ongoing replicated transmission on link 1. The receiver MLD also sends an ACK on link 1 to notify the transmitter MLD about the successful reception of the replicated transmission on link 2. Subsequently, the transmitter MLD sends a next instance of replicated transmissions on both links. For this instance of replicated transmissions RI is set to 1 and RT is toggled to 1, because the previous instance was successfully received and acknowledged. Upon successfully receiving the replicated transmission on link 1, the receiver MLD sends an ACK on link 1. Upon receiving the ACK on link 1, the transmitter MLD stops its ongoing replicated transmission on link 2 with an CF-End (Contention Free End) frame, illustrated by a box with broken outline. Subsequently, the transmitter MLD sends a still further instance of replicated transmissions on both links. For this instance of replicated transmissions RI is set to 1 and RT is toggled to 0, because the previous instance was successfully received and acknowledged. In this instance, the receiver MLD successfully receives the replicated transmission on link 2, sends an ACK on link 2, and stops decoding the ongoing replicated transmission on link 1. The receiver MLD further sends an ACK on link 1. As indicated by crossing out, the ACK on link 2 is not successfully received by the transmitter MLD. However, the transmitter MLD is still informed by the ACK on link 1 that the replicated transmission of this instance was successfully received by the receiver MLD and thus again toggles the RT.

In the example of FIG. 5B, the transmitter MLD sends replicated transmissions on both links. For these replicated transmissions RI is set to 1 and RT is set to 0. As indicated by crossing out, the receiver MLD fails to successfully receive both replicated transmissions, and thus does not send an ACK. The transmitter MLD thus refrains from toggling RT and retransmits the replicated transmissions on both links. In this retry, the receiver MLD again fails to successfully receive the replicated transmission on link 2, as indicated by crossing out, but manages to successfully receive the replicated transmission on link 1. As a result, the receiver MLD sends ACKs on both links, which are successfully received by the transmitter MLD and cause toggling of RT to 1. Subsequently, the transmitter MLD sends a next instance of replicated transmissions on both links, with RI and RT set to 1. In this instance, a replicated transmission on link 1 finishes first and is successfully received by the receiver MLD. The receiver MLD thus sends an ACK on link 1 which, as indicated by crossing out, is however not successfully received by the transmitter MLD, causing the transmitter MLD to retransmit the replicated transmission on link 1. For this retransmission, the receiver MLD notices early, based on the setting of RI=1 and RT=1, that it corresponds to a retransmission of the replicated transmission which was already successfully received, stops decoding the retransmission of the replicated transmission on link 1, and sends a further ACK on link 1. However, as indicated by crossing out, also this further ACK on link 1 is not successfully received by the transmitter MLD. Then, the ongoing replicated transmission on link 2 finishes, resulting in successful reception by the receiver MLD. The receiver MLD thus sends an ACK on link 2, which is successfully received by the transmitter MLD, causing toggling of RT back to 0.

In the example of FIG. 5C, the transmitter MLD sends replicated transmissions on both links. For these replicated transmissions RI is set to 1 and RT is set to 0. The receiver MLD thus sends an ACK on link 1, which is successfully received by the transmitter MLD. In response to the ACK on link 1, the transmitter MLD stops the replicated transmission on link 2 with an CF-End frame, illustrated by a box with broken outline. Subsequently, the transmitter MLD sends a next instance of replicated transmissions on both links. For this instance of replicated transmissions RI is set to 1 and RT is toggled to 1, because the previous instance was successfully received and acknowledged. Upon successfully receiving the replicated transmission on link 1, the receiver MLD sends an ACK on link 1 and stops decoding the still ongoing replicated transmission on link 2. As indicated by crossing out, this ACK on link 1 however is not successfully received by the transmitter MLD, causing the transmitter MLD to retransmit the replicated transmission on link 1. After the replicated transmission on link 2 finishes, the receiver MLD sends an ACK on link 2. This ACK on link 2 is successfully received by the transmitter MLD, causing the transmitter MLD to stop its still ongoing retransmission on link 1 with an CF-End frame, illustrated by a box with broken outline. For the retransmission on link 1, the receiver MLD notices early, based on the setting of RI=1 and RT=1, that it corresponds to a retransmission of the replicated transmission which was already successfully received and stops decoding the retransmission of the replicated transmission on link 1. Subsequently, the transmitter MLD sends a still further instance of replicated transmissions on both links. For this instance of replicated transmissions RI is set to 1 and RT is toggled back to 0, because the previous instance was successfully received and acknowledged. As indicated by crossing out, the receiver MLD fails to successfully receive both replicated transmissions of this instance, and thus does not send an ACK. The transmitter MLD thus refrains from toggling RT and retransmits the replicated transmissions on both links. In this retry, the replicated transmission on link 2 starts earlier than the replicated transmission on link 1, e.g., due to the medium of link 1 being occupied. The receiver MLD successfully receives the replicated transmission on link 2 already before the replicated transmission on link 1 starts. The receiver MLD thus sends an ACK on link 2. As indicated by crossing out, the transmitter MLD fails to successfully receive the ACK on link 2 and thus does not cancel the retransmission on link 1. For the retransmission on link 1, the receiver MLD notices early, based on the setting of RI=1 and RT=0, that it corresponds to a retransmission of the replicated transmission which was already successfully received and stops decoding the retransmission of the replicated transmission on link 1 and, after the retransmission finishes, sends an ACK on link 1, which is successfully received by the transmitter MLD, causing toggling of RT back to 1.

As mentioned above, based on the announcement of the ML replication, the transmitter MLD and/or the receiver MLD may adapt their operation in relation to the replicated transmissions on the multiple wireless links. This adaptation may involve overriding a requirement of to align end-times of the corresponding PPDUs transmitted over the multiple wireless links. Correspondingly, even if the end-times of these PPDUs are not aligned, an NSTR receiver MLD is allowed to transmit an ACK on one wireless link during ongoing reception of the replicated transmission the other wireless link(s). This adapted operation may help to reduce latency, and the achievable reduction of latency may be quite significant because the capacity of the wireless links may vary considerably. For example, the wireless links could include a first wireless link with 20 MHz bandwidth in the 2.4 GHz band and a second wireless link with 160 MHz bandwidth in the 6 GHz band. In this case, successful reception on the second wireless link may occur much earlier than successful reception on the first link, so that there is a significant reduction in latency if it is possible to send the ACK on the second link while the replicated transmission on the first link still continues. Furthermore, if the transmitter MLD is not forced to align the end-times of the PPDUs, it can be easier to gain access to the medium of the respective wireless link. the channels in order to actually perform the replication. This aspect is illustrated by FIGS. 5A, 5B, and 5C.

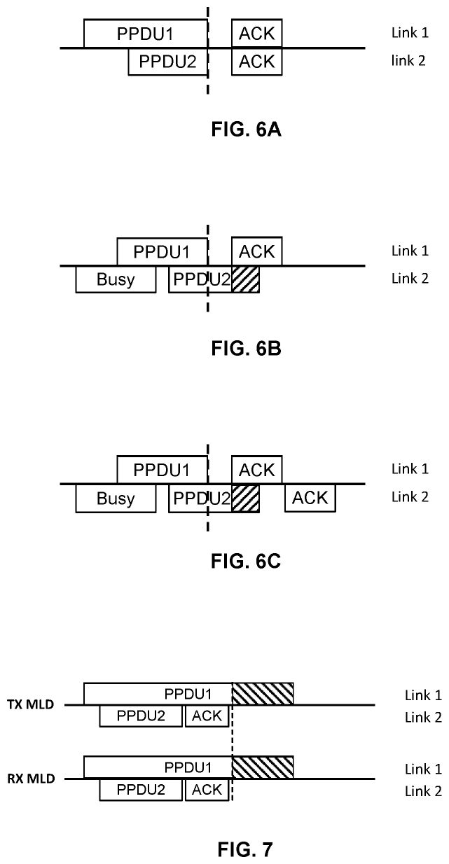

FIG. 6A shows an example of a scenario where the transmitter MLD performs time alignment of PPDUs, denoted as PPDU1 and PPDU2, transmitted based on using ML replication on a first wireless link, denoted as “link 1” and a second wireless link, denoted as “link 2”. In this scenario, an ACK on link 1 and an ACK on link 2 are transmitted at the same time.

FIG. 6B is an example of a scenario where end-time alignment PPDU1 and PPDU2 is not possible due to the wireless medium of link 2 being busy. As can be seen, in this case, the transmission of PPDU2 on link 2 still continues when the ACK on link 1 is transmitted. For a NSTR receiver MLD, this may result in failure to successfully receive PPDU2 or could force the receiver MLD to delay transmission of the ACK on link 1, if the receiver MLD is not aware that PPDU2 corresponds to a replicated transmission which was already successfully received.

FIG. 6C is an example of a scenario where a requirement of end-time alignment PPDU1 and PPDU2 is overridden based on the announcement of the ML replication. In this case, the receiver MLD knows from the announcement of the ML replication on link 1 and link 2 that PPDU2 is a replicated transmission which was already successfully received, so that failure to successfully receive PPDU2 is acceptable. As a result, the receiver MLD also sends an ACK on link 2.

In addition or as alternative, the adaptation of operation may involve that, if the wireless medium of one of the wireless links is busy, the receiver MLD refrains from searching the wireless link for a replicated transmission if the receiver MLD receives a corresponding replicated transmission on another wireless link.

In addition or as alternative, the adaptation of operation may involve considering limited functionality of the receiver MLD. Examples of such limited functionality of the receiver MLD are if it operates in an EMLSR or EMLMR mode. In such case, in response to the announcement of the ML replication, the receiver MLD could select an appropriate wireless link and receive the corresponding replicated transmission only over the selected wireless link, using all its radio chains. This may for example enable that the receiver MLD selects and receives on the wireless link having the best channel quality. This selection of the wireless link having the best channel quality may be regarded as being similar to switched diversity, but since the radio interface of the receiver MLD has limited functionality, some further criteria may need to be considered. For example, in some scenarios the receiver MLD may have only one receiver chain that can do full reception processing, in the following denoted as “full receiver”, including decoding of data, and optionally another receiver chain can be used for performing listen before talk (LBT) and/or making a rough assessment of the channel quality. The latter receiver chain will in the following also be denoted as “limited receiver”. For such receiver MLD having limited functionality, the ML replication can still be used when controlling the selection of wireless links and receiver chains in such a way that the full receiver is used on the wireless link having the best conditions, whereas no reception of data will be performed on the other wireless link. Accordingly, the receiver MLD may need to determine which of the wireless links is most suitable.

Since there is a possibility that the full receiver may need to switch from one channel to another, it is desirable that no essential information is lost even though a part of the transmission might not be processed since it is received during the switching time. To achieve this, the replicated transmissions on the wireless links may be transmitted slightly staggered in time. The full receiver may then be first allocated to the wireless link where the sequence of replicated transmissions starts. It may be configured beforehand in the transmitter MLD and the receiver MLD on which one of the wireless links the sequence of replicated transmissions will start, so that the receiver MLD can initially allocate the full receiver to this wireless link. During reception on this wireless link, the receiver MLD may determine whether the channel quality is sufficient, typically taking into account the measured channel quality and the utilized modulation and coding scheme (MCS). If the receiver MLD determines that the channel quality is not sufficient to support the utilized MCS, the receiver MLD may switch the full receiver to the other wireless link. In this way, the probability of finding a wireless link having sufficient channel quality can be increased. The staggering of the replicated transmissions on the wireless links may be selected based on a trade-off between minimizing the total transmission time and enabling sufficient processing on the currently received wireless link to estimate whether switching to the other wireless link is preferred.

In some implementations, the limited receiver may also be used in the selection of the wireless link to be used for reception of the replicated transmission. In this case, the full receiver and the limited receiver may simultaneously receive on two different wireless links. If the full receiver is allocated to a wireless link which is estimated to have a sufficient channel quality, it may continue to receive on this wireless link. However, if it is determined that the channel quality is not sufficient, or possibly that the channel quality on the other wireless link is better, the full receiver may be switched to the other wireless link. The difference as compared to the above approach of using staggered transmission is the possibility to consider the channel quality of both wireless links in parallel. In this case, the switch is done if the limited receiver indicates a sufficient channel quality on its wireless link. The measurements of the limited receiver to estimate the channel quality could for example be performed on a first part of a legacy preamble of the replicated transmissions, e.g., on a part referred to as L-STF (non-HT Short Training Field). The full receiver could then use the remaining part of the replicated transmission to perform channel estimation and further processing. In this case, the limited receiver may perform coarse time and frequency estimation, which can then be used by the full receiver to perform the continued processing, thereby taking into account that the full receiver was not able to process the first part of the replicated transmission. Alternatively, if it is not possible for the full receiver to perform the switching between the wireless links sufficiently fast, the first part of the replicated transmission may be buffered, so that the buffered first part can be fed to the full receiver after the switching of the wireless links.

As mentioned above, it may be beneficial if the receiver MLD knows on which wireless link replicated transmissions will start, so that the full receiver can be initially allocated to this wireless link. Corresponding information may be provided to the receiver MLD by signalling between the transmitter MLD and the receiver MLD. If information on which wireless link the replicated transmission will start is not available at the receiver MLD, there is a risk that reception will initially be performed by the limited receiver. In this case, if the channel quality measured by the limited receiver is found to be sufficient, the receiver MLD may switch the full receiver and the limited receiver between the wireless links, so that the full receiver is allocated to where the replicated transmissions started. After that, another switch may be triggered if a replicated transmission also starts on the other wireless link and the limited receiver detects that the channel quality of this wireless link is better.

Further, the announcement of the ML replication may also be used as a basis for efficiently controlling sending of ACKs for replicated transmissions received on the multiple wireless links. In particular, in response to the announcement the receiver MLD can decide that it is sufficient to fully decode only a single replication of a certain transmission and notify the transmitter MLD about its successful reception, by sending an ACK. Accordingly, upon successful reception of a replicated transmission on one wireless link, the receiver MLD may send an ACK for this replicated transmission on any of the wireless links used in the ML replication. Examples of such type of operation are included in the examples of FIGS. 5A, 5B, and 5C.

Further, as soon as the receiver MLD has correctly decoded one replicated transmission on a certain wireless link, the receiver MLD may stop decoding the replicated transmissions on the other wireless link(s). In such cases, the receiver MLD may thus refrain from even attempting to decode replicated transmissions which would be redundant. The ACK sent to the transmitter MLD may then also include an indication that the receiver MLD has only attempted to fully decode on a single wireless link. In response to such indication, the transmitter MLD may refrain from attempting to infer information on transmission success or failure of the corresponding replicated transmission(s) the other wireless link(s).

Further, based on the announcement of the ML replication, the receiver MLD may send an ACK on only one wireless link. The wireless link on which the ACK shall be sent may be configured in the receiver MLD and typically also in the transmitter MLD, e.g., based on signalling between the transmitter MLD and the receiver MLD. In some cases, such configuration may also involve that the receiver MLD shall send the ACK for acknowledging successful reception of a replicated transmission on one wireless link on another wireless link, which is different from the wireless link on which the replicated transmission was successfully received.

Further, the ACK for acknowledging successful reception of a replicated transmission on a wireless link may also include information indicating on which one of the wireless links the replicated transmission was successfully and/or information on channel conditions, e.g., channel quality or channel occupation, of the one or more of the wireless links. For example, if a replicated transmission is successfully received on a first link, before the corresponding replicated transmission finishes or is completely decoded on a second wireless link, the receiver MLD can send an ACK on the first wireless link. If the receiver MLD however detects that the channel quality of the second wireless link is better than the channel quality of the first wireless link, the receiver MLD can inform the transmitter MLD accordingly by including corresponding information into the ACK. Based on such information the transmitter MLD could then for example decide to increase the data rate on the second wireless link, so that upcoming replicated transmissions on the second wireless link can benefit from higher performance, irrespective of interruption of an earlier replicated transmission on the second wireless link. As a result, link adaptation on the wireless links can be performed in an efficient manner, even if some replicated transmissions are not completely decoded or interrupted.

As mentioned above, if a replicated transmission over a first wireless link is successfully decoded earlier than the corresponding replicated transmission over a second wireless link, it would be unnecessary for the receiver MLD to continue decoding the replicated transmission over the second wireless link, since it contains the same content. This also applies if corresponding replicated transmissions are transmitted sequentially over the same wireless link. Accordingly, when a replicated transmission is successfully decoded, then the receiver MLD may terminate or cancel its decoding attempts of the corresponding replicated transmissions on the same wireless link and on other wireless links. The termination or cancellation may be full or partial. Examples of such termination or cancellation are included in the examples of FIGS. 5A, 5B, and 5C. The early termination or cancellation may help to save resources, e.g., in terms of battery power.

In a similar manner, the transmitter MLD may terminate or cancel replicated transmissions having a counterpart which was already successfully received. In this way, the transmitter MLD can take into account that, if a replicated transmission was already successfully received, it would be a waste of resources to continue transmitting the corresponding replicated transmissions. Also at the transmitter MLD, the termination or cancellation may be full or partial. Further, if the transmitter MLD had reserved resources for the replicated transmissions, e.g., in terms of a transmission opportunity (TXOP), the transmitter MLD may send a CF-End frame following the termination or cancellation of the replicated transmission. By sending the CF-End frame, the transmitter may truncate the TXOP and release the reservation of the medium. Upon detecting a CF-End frame, the receiver MLD would not transmit an ACK for the corresponding replicated transmission. Examples of such termination or cancellation are included in the examples of FIGS. 5A, 5B, and 5C.

FIG. 7 shows a further example for schematically illustrating how the transmitter MLD (TX MLD) may terminate a replicated transmission upon receiving an ACK and how the receiver MLD (RX MLD) may terminate reception upon successfully receiving a corresponding replicated transmission. In the example of FIG. 7, the transmitter MLD sends replicated transmissions, denoted as PPDU1 and PPDU2, on two links, denoted as “link 1” and “link 2”. The replicated transmission on link 2 finishes earlier and is successfully received by the receiver MLD. The receiver MLD thus sends an ACK on link 2 and terminates further decoding of the ongoing corresponding replicated transmission on link 1. Upon successfully receiving the ACK, the transmitter MLD terminates further transmission of the replicated transmission on link 1.

In view of the above, an example of a procedure for controlling transmissions using ML replication may be as follows: Initially, the transmitter MLD sets RI=1 and toggles RT. Further, the transmitter MLD initiates channel access for the replicated transmissions on two wireless links. Then the receiver MLD detects the setting of RI and RT and prepares for reception of the replicated transmissions. In the course of the replicated transmissions, the receiver MLD sends an ACK for the replicated transmission that is first successfully received by the receiver MLD. Optionally, the receiver MLD cancels or terminates any decoding attempt for corresponding replicated transmissions. Here, a corresponding replicated transmission may be identified as a replicated transmission which has the same setting of RI and RT as the successfully received frame. If the transmitter MLD successfully receives the ACK, it terminates or cancels any corresponding replicated transmissions which is not yet finished. Further, the transmitter MLD may transmit a CF-End frame on one or both wireless links to release reservation of the wireless medium. If the transmitter MLD fails to receive the ACK, it continues or retry sending the replicated transmissions with the same setting of RI and RT. If the receiver MLD detects a continued or retried replicated transmission on any of the wireless links even though the receiver MLD already sent an ACK for this replicated transmission, the receiver MLD again sends an ACK to notify the earlier successful reception of the replicated transmission. This may be accomplished without fully decoding the continued or retried replicated transmission. If the receiver MLD detects a CF-End frame on any wireless link, it may prepare for a fresh reception or may start contending for undertaking its own transmission on that wireless link.

In some scenarios, the replicated transmissions may be performed by APs which are not affiliated with the same AP MLD. For example, if a first AP and a second AP are two non-collocated APs and are not affiliated with the same AP MLD, a first wireless link may be used for transmissions from the first AP to a first STA affiliated with a non-AP MLD, and a second wireless link may be used for transmissions from the second AP to a second STA affiliated with the same non-AP MLD. In this case, the first link and the second link would most likely experience different channel conditions, for example in terms of path losses or the like. Due to such possible difference in the underlying channel conditions and thus in the wireless paths taken by the replicated transmissions, such multi-AP multi-link replicated transmissions may help to improve the probability of successful reception at the non-AP MLD. Beside this aspect, the replicated transmissions may otherwise be performed as described above, assuming that the two APs are suitably connected, e.g., though a cable connection, and thus coordinated in some sense. In this example, the transmitter MLD side may include STAs not affiliated with the same MLD, which in the considered example are AP STAs. Thus, the replicated transmissions are not performed by STAs affiliated with the same transmitter MLD. Rather, the replicated transmissions are received by STAs affiliated with the same receiver MLD.

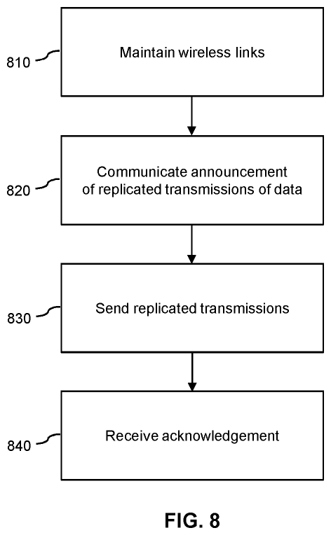

FIG. 8 shows a flowchart for illustrating a method, which may be utilized for implementing the illustrated concepts. The method of FIG. 8 may be used for implementing the illustrated concepts in a wireless communication device operating in a wireless communication system. The wireless communication device could for example be a non-AP STA, such as any of the above-mentioned STAs 11. Alternatively, the wireless communication device could be an AP of the wireless communication system, e.g., any of the above-mentioned APs 10. The wireless communication system may be based on a WLAN technology, e.g., according to the IEEE 802.11 standards family. The wireless communication device may correspond to the transmitter MLD of the above examples.

If a processor-based implementation of the wireless communication device is used, at least some of the steps of the method of FIG. 8 may be performed and/or controlled by one or more processors of the the wireless communication device. Such wireless communication device may also include a memory storing program code for implementing at least some of the below described functionalities or steps of the method of FIG. 8.

At step 810, the wireless communication device maintains a first wireless link and a second wireless link to a further wireless communication device. The further wireless communication device could for example be a non-AP STA, such as any of the above-mentioned STAs 11. Alternatively, the further wireless communication device could be an AP of the wireless communication system, e.g., any of the above-mentioned APs 10. In some scenarios, the wireless communication device corresponds to an AP of the wireless communication system and the further wireless communication device corresponds to a wireless station, in particular to an non-AP STA associated with the AP. Alternatively, the further wireless communication device corresponds to an AP of the wireless communication system and the wireless communication device corresponds to a wireless station, in particular to an non-AP STA associated with the AP.

The first wireless link and the second wireless link may be based on different frequency channels, e.g., from different frequency bands, such as the 2.4 GHz band, 5 GHz band, or 6 GHz band.

At step 820, the wireless communication device communicates, between the wireless communication device and the further wireless communication device, an announcement of replicated transmissions of data on the first wireless link and the second wireless link.

In some scenarios, step 820 may involve that the wireless communication device sends the announcement of the replicated transmissions to the further wireless communication device. For example, the wireless communication device could send each of the replicated transmissions of the data in a respective payload section of a PPDU and include the announcement of the replicated transmissions in a header section of the PPDU, e.g., as illustrated in FIG. 2B. Alternatively or in addition, the wireless communication device could send each of the replicated transmissions of the data in a respective payload section of an MPDU and include the announcement of the replicated transmissions in a header section of the MPDU, e.g., as illustrated in FIG. 2C.

Alternatively or in addition, the wireless communication device could send an RTS frame to the further wireless communication device, in response to sending the RTS frame, receive a CTS frame from the further wireless communication device, and send the replicated transmissions of the data in response to receiving the CTS frame. In this case, the RTS frame could include the announcement of the replicated transmissions. The processes of FIG. 3 constitute an example of including the announcement in an RTS frame.

Alternatively or in addition, step 820 may involve that the wireless communication device receives the announcement of the replicated transmissions from the further wireless communication device. For example, the wireless communication device could receive a TF from the further wireless communication device and send the replicated transmissions of the data in response to receiving the TF. In this case, the TF may include the announcement of the replicated transmissions.

In some scenarios, the announcement of the replicated transmissions may include a first indicator indicating usage of replication for transmission of data, such as the above-mentioned RI. Further, the announcement of the replicated transmissions may include a second indicator indicating whether an upcoming replicated transmission corresponds to new data, such as the above-mentioned RT. The second indicator may be toggled if the upcoming replicated transmission corresponds to new data.

At step 830, the wireless communication device sends the replicated transmissions of the data on the first wireless link and the second wireless link.

In some scenarios, step 830 may involve that, in response to receiving an acknowledgement indicating successful reception of the data from one of the replicated transmissions, the wireless communication device stops or cancels other replicated transmissions of the data.

At step 840, the wireless communication device may optionally receive an acknowledgement. For example, based on the announcement of the replicated transmissions communicated at step 820, the wireless communication device may expect an acknowledgement of successful reception of the data on only one of the first wireless link and the second wireless link. The wireless communication device may then receive the acknowledgement on this wireless link.

In some scenarios, the wireless communication device may receive the acknowledgement of the replicated transmissions on that one of the first wireless link and the second wireless link on which the data was successfully received by the further wireless communication device. Alternatively or in addition, the wireless communication device may receive the acknowledgement on the other of the first wireless link and the second wireless link on which the data was successfully received by the further wireless communication device.

In some scenarios, a wireless link between the wireless communication device and the further wireless communication device is configured to be used for transmission of acknowledgements for successful reception of data, and the wireless communication device may receive the acknowledgement on the configured wireless link. The configured wireless link could be one of the first wireless link and the second wireless link. Alternatively, the configured wireless link could be different from the first wireless link and the second wireless link.

In some scenarios, the further wireless communication device is classified as NSTR with respect to the first wireless link and the second wireless link, and the wireless communication device receives the acknowledgement during one of the replicated transmissions.

In some scenarios, the further wireless communication device is classified as NSTR with respect to the first wireless link and the second wireless link and an end-time of a replicated transmissions on the first wireless link is not required to be aligned with an end-time of a replicated transmission on the second wireless link.

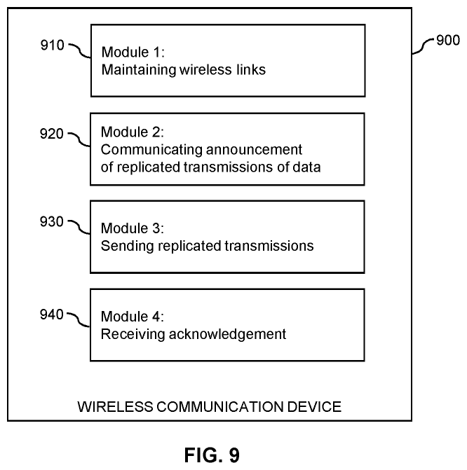

FIG. 9 shows a block diagram for illustrating functionalities of a wireless communication device 900 which operates according to the method of FIG. 8. The wireless communication device 900 may for example correspond to one of the above-mentioned APs 10 or STAs 11. As illustrated, the wireless communication device 900 may be provided with a module 910 configured to maintain a first wireless link and a second wireless link, such as explained in connection with step 810. Further, the wireless communication device 900 may be provided with a module 920 configured communicate an announcement of replicated transmissions, such as explained in connection with step 820. Further, the wireless communication device 900 may be provided with a module 930 configured to send replicated transmissions, such as explained in connection with step 830. Further, the wireless communication device 900 may be provided with a module 940 configured to receive an acknowledgement, such as explained in connection with step 840.

It is noted that the wireless communication device 900 may include further modules for implementing other functionalities, such as known functionalities of a WLAN AP or other WLAN STA. Further, it is noted that the modules of the wireless communication device 900 do not necessarily represent a hardware structure of the wireless communication device 900, but may also correspond to functional elements, e.g., implemented by hardware, software, or a combination thereof.

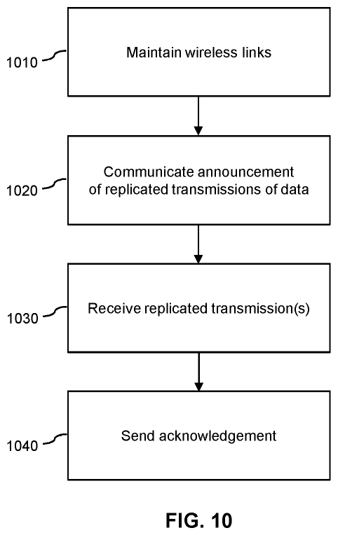

FIG. 10 shows a flowchart for illustrating a method, which may be utilized for implementing the illustrated concepts. The method of FIG. 10 may be used for implementing the illustrated concepts in a wireless communication device operating in a wireless communication system. The wireless communication device could for example be a non-AP STA, such as any of the above-mentioned STAs 11. Alternatively, the wireless communication device could be an AP of the wireless communication system, e.g., any of the above-mentioned APs 10. The wireless communication system may be based on a WLAN technology, e.g., according to the IEEE 802.11 standards family. The wireless communication device may correspond to the receiver MLD of the above examples.

If a processor-based implementation of the wireless communication device is used, at least some of the steps of the method of FIG. 10 may be performed and/or controlled by one or more processors of the wireless communication device. Such the wireless communication device may also include a memory storing program code for implementing at least some of the below described functionalities or steps of the method of FIG. 10.

At step 1010, the wireless communication device maintains a first wireless link and a second wireless link to a further wireless communication device. The further wireless communication device could for example be a non-AP STA, such as any of the above-mentioned STAs 11. Alternatively, the further wireless communication device could be an AP of the wireless communication system, e.g., any of the above-mentioned APs 10. In some scenarios, the wireless communication device corresponds to an AP of the wireless communication system and the further wireless communication device corresponds to a wireless station, in particular to an non-AP STA associated with the AP. Alternatively, the further wireless communication device corresponds to an AP of the wireless communication system and the wireless communication device corresponds to a wireless station, in particular to an non-AP STA associated with the AP.

The first wireless link and the second wireless link may be based on different frequency channels, e.g., from different frequency bands, such as the 2.4 GHz band, 5 GHz band, or 6 GHz band.

At step 1020, the wireless communication device communicates, between the wireless communication device and the further wireless communication device, an announcement of replicated transmissions of data on the first wireless link and the second wireless link.

In some scenarios, step 1020 may involve that the wireless communication device receives the announcement of the replicated transmissions from the further wireless communication device. For example, the wireless communication device could receive each of the replicated transmissions of the data in a respective payload section of a PPDU, and the announcement of the replicated transmissions could be included in a header section of the PPDU, e.g., as illustrated in FIG. 2B. Alternatively or in addition, the wireless communication device could receive each of the replicated transmissions of the data in a respective payload section of an MPDU, and the announcement of the replicated transmissions could be included in a header section of the MPDU, e.g., as illustrated in FIG. 2C.

Alternatively or in addition, the wireless communication device could receive an RTS frame from the further wireless communication device, in response to receiving the RTS frame, send a CTS frame from the further wireless communication device, and receive the replicated transmissions of the data in response to sending the CTS frame. In this case, the RTS frame could include the announcement of the replicated transmissions. The processes of FIG. 3 constitute an example of including the announcement in an RTS frame.

Alternatively or in addition, step 1020 may involve that the wireless communication device sends the announcement of the replicated transmissions from the further wireless communication device. For example, the wireless communication device could send a TF to the further wireless communication device and receive the replicated transmissions of the data in response to sending the TF. In this case, the TF may include the announcement of the replicated transmissions.

In some scenarios, the announcement of the replicated transmissions may include a first indicator indicating usage of replication for transmission of data, such as the above-mentioned RI. Further, the announcement of the replicated transmissions may include a second indicator indicating whether an upcoming replicated transmission corresponds to new data, such as the above-mentioned RT. The second indicator may be toggled if the upcoming replicated transmission corresponds to new data.

At step 1030, the wireless communication device receives one or more of the replicated transmissions of the data on at least one of the first wireless link and the second wireless link.

In some scenarios, step 1030 may involve that, in response to successfully receiving the data from one of the replicated transmissions, the wireless communication device stops ongoing reception of another replicated transmission of the data.

In some scenarios, step 1030 may involve that, based on the announcement of the replicated transmissions, the wireless communication device selects one of the first wireless link and the second wireless link for receiving the data.

At step 1040, the wireless communication device may optionally send an acknowledgement. For example, based on the announcement of the replicated transmissions communicated at step 820, the wireless communication device may send an acknowledgement of successful reception of the data on only one of the first wireless link and the second wireless link.

In some scenarios, the wireless communication device may send the acknowledgement of the replicated transmissions on that one of the first wireless link and the second wireless link on which the data was successfully received by the wireless communication device. Alternatively or in addition, the wireless communication device may send the acknowledgement on the other of the first wireless link and the second wireless link on which the data was successfully received by the wireless communication device.

In some scenarios, a wireless link between the wireless communication device and the further wireless communication device is configured to be used for transmission of acknowledgements for successful reception of data, and the wireless communication device may send the acknowledgement on the configured wireless link. The configured wireless link could be one of the first wireless link and the second wireless link. Alternatively, the configured wireless link could be different from the first wireless link and the second wireless link.

In some scenarios, the wireless communication device is classified as NSTR with respect to the first wireless link and the second wireless link, and the wireless communication device may send the acknowledgement during one of the replicated transmissions.

In some scenarios, the wireless communication device is classified as NSTR with respect to the first wireless link and the second wireless link and an end-time of a replicated transmissions on the first wireless link is not required to be aligned with an end-time of a replicated transmission on the second wireless link.

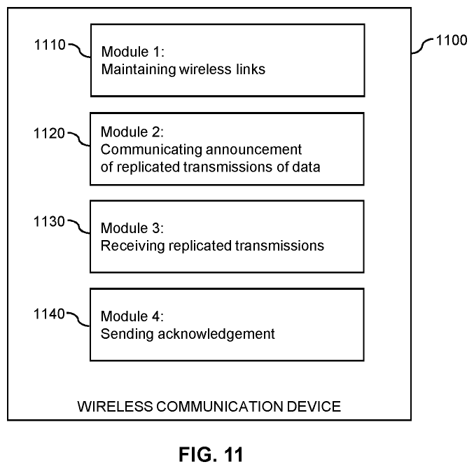

FIG. 11 shows a block diagram for illustrating functionalities of a wireless communication device 1100 which operates according to the method of FIG. 10. The wireless communication device 1100 may for example correspond to one of the above-mentioned APs 10 or STAs 11. As illustrated, the wireless communication device 1100 may be provided with a module 1110 configured to maintain a first wireless link and a second wireless link, such as explained in connection with step 1010. Further, the wireless communication device 1100 may be provided with a module 1120 configured communicate an announcement of replicated transmissions, such as explained in connection with step 1020. Further, the wireless communication device 1100 may be provided with a module 1130 configured to send replicated transmissions, such as explained in connection with step 1030. Further, the wireless communication device 1100 may be provided with a module 1140 configured to send an acknowledgement, such as explained in connection with step 1040.

It is noted that the wireless communication device 1100 may include further modules for implementing other functionalities, such as known functionalities of a WLAN AP or other WLAN STA. Further, it is noted that the modules of the wireless communication device 1100 do not necessarily represent a hardware structure of the wireless communication device 1100, but may also correspond to functional elements, e.g., implemented by hardware, software, or a combination thereof.

It is noted that the functionalities as described in connection with FIGS. 8 to 11 could also be implemented in a system, e.g., a system including a first wireless communication device operating according to the method of FIG. 8 and a second wireless communication device operating according to the method of FIG. 10, with the first wireless communication device acting as the transmitter of the replicated transmissions and the second wireless communication device acting as the receiver of the replicated transmissions. Further, it is noted that the functionalities as described in connection with FIGS. 8 to 11 could also be combined in the same wireless communication device, acting as transmitter of replicated transmissions and as receiver of the replicated transmissions, e.g., in a scenario involving bi-directional communication based on ML replication.

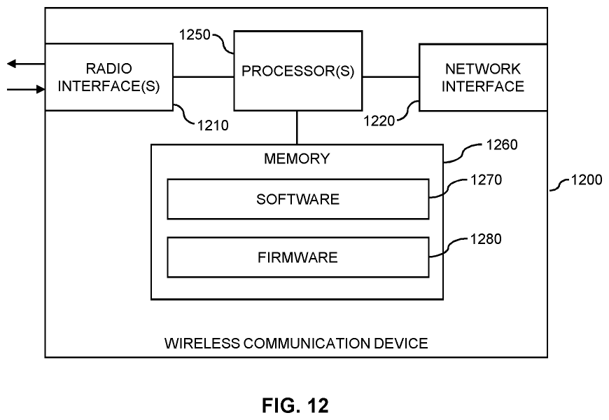

FIG. 12 illustrates a processor-based implementation of wireless communication device 1200 which may be used for implementing the above-described concepts. For example, the structures as illustrated in FIG. 12 may be used for implementing the concepts in any of the above-mentioned APs 10 or STAs 11.

As illustrated, the wireless communication device 1200 includes one or more radio interfaces 1210. The radio interface(s) 1210 may for example be based on a WLAN technology, e.g., according to an IEEE 802.11 family standard. However, other wireless technologies could be supported as well, e.g., the LTE technology or the NR technology. The radio interface(s) 1210 may be based on multiple radios to support MLO of the wireless communication device 1200. As further illustrated, the wireless communication device 1200 may also include one or more network interfaces 1220 which may be used for communication with other nodes of a wireless communication network, e.g., with other APs or with an application service platform as illustrated in FIG. 1.

Further, the wireless communication device 1200 may include one or more processors 1250 coupled to the interface(s) 1210, 1220 and a memory 1260 coupled to the processor(s) 1250. By way of example, the interface(s) 1210, 1220 the processor(s) 1250, and the memory 1260 could be coupled by one or more internal bus systems of the wireless communication device 1200. The memory 1260 may include a ROM (Read Only Memory), e.g., a flash ROM, a RAM (Random Access Memory), e.g., a DRAM (Dynamic RAM) or SRAM (Static RAM), a mass storage, e.g., a hard disk or solid state disk, or the like. As illustrated, the memory 1260 may include software 1270 and/or firmware 1280. The memory 1260 may include suitably configured program code to be executed by the processor(s) 1250 so as to implement the above-described functionalities for controlling wireless transmissions, such as explained in connection with FIGS. 8 to 11.

It is to be understood that the structures as illustrated in FIG. 12 are merely schematic and that the wireless communication device 1200 may actually include further components which, for the sake of clarity, have not been illustrated, e.g., further interfaces or further processors. Also, it is to be understood that the memory 1260 may include further program code for implementing known functionalities of a WLAN AP or other WLAN STA. According to some embodiments, also a computer program may be provided for implementing functionalities of the wireless communication device 1200, e.g., in the form of a physical medium storing the program code and/or other data to be stored in the memory 1260 or by making the program code available for download or by streaming.

As can be seen, the concepts as described above may be used for efficiently enabling replicated transmissions between MLDs. For example, the concepts may allow for reducing of control signaling overhead, e.g., ACKs, as well as for reducing unnecessary replicated transmissions, which in turn also allows for saving resources of the wireless medium. Further, it may be possible to reduce latency, which is beneficial for critical data and also allows to improve power efficiency because unnecessary transmission, reception, and decoding of replicated transmissions can be avoided. Further, it may be possible to efficiently implement a time-sensitive networking (TSN) functionality over a wireless medium.

It is to be understood that the examples and embodiments as explained above are merely illustrative and susceptible to various modifications. For example, the illustrated concepts may be applied in connection with various kinds of wireless technologies, without limitation to WLAN technologies. Further, the concepts may be applied with respect to various types of APs and STAs. Further, the illustrated concepts may be applied to various combinations of channels and channels from various frequency bands. Further, the above concepts as explained for a pair of wireless links could also be extended to three or more wireless links.

Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-48. (canceled)

49. A method of controlling wireless transmissions in a wireless communication system, the method comprising:
a wireless communication device maintaining a first wireless link and a second wireless link to a further wireless communication device, the first wireless link and the second wireless link being based on different frequency channels;
the wireless communication device communicating, between the wireless communication device and the further wireless communication device, an announcement of replicated transmissions of data on the first wireless link and the second wireless link;
the wireless communication device sending the replicated transmissions of the data on the first wireless link and the second wireless link; and
based on the announcement of the replicated transmissions, the wireless communication device expecting an acknowledgement of successful reception of the data on only one of the first wireless link and the second wireless link.

50. The method according to claim 49, comprising:
the wireless communication device sending the announcement of the replicated transmissions to the further wireless communication device.

51. The method according to claim 50, comprising:
the wireless communication device sending each of the replicated transmissions of the data in a respective payload section of a Physical Layer Protocol Data Unit (PPDU); and
the wireless communication device including the announcement of the replicated transmissions in a header section of the PPDU.

52. The method according to claim 50, comprising:
the wireless communication device sending each of the replicated transmissions of the data in a respective payload section of a Medium Access Control Protocol Data Unit (MPDU); and
the wireless communication device including the announcement of the replicated transmissions in a header section of the MPDU.

53. The method according to claim 50, comprising:
the wireless communication device sending a Request to Send (RTS) frame to the further wireless communication device;
in response to sending the RTS frame, the wireless communication device receiving a Clear to Send (CTS) frame from the further wireless communication device; and
the wireless communication device sending the replicated transmissions of the data in response to receiving the CTS frame,
wherein the RTS frame includes the announcement of the replicated transmissions.

54. The method according to claim 49, comprising the wireless communication device receiving the announcement of the replicated transmissions from the further wireless communication device.

55. The method according to claim 54, comprising:
the wireless communication device receiving a trigger frame from the further wireless communication device; and
the wireless communication device sending the replicated transmissions of the data in response to receiving the trigger frame, wherein the trigger frame includes the announcement of the replicated transmissions.

56. The method according to claim 49, wherein the wireless communication device receives the acknowledgement on that one of the first wireless link and the second wireless link on which the data was successfully received by the further wireless communication device.

57. The method according to claim 49, wherein the wireless communication device receives the acknowledgement on the other of the first wireless link and the second wireless link on which the data was successfully received by the further wireless communication device.

58. The method according to claim 49, wherein a wireless link between the wireless communication device and the further wireless communication device is configured to be used for transmission of acknowledgements for successful reception of data and the wireless communication device receives the acknowledgement on the configured wireless link.

59. The method according to claim 49, wherein the further wireless communication device is classified as non-simultaneous transmit and receive with respect to the first wireless link and the second wireless link and the wireless communication device receives the acknowledgement during one of the replicated transmissions.

60. The method according to claim 49, wherein the further wireless communication device is classified as non-simultaneous transmit and receive with respect to the first wireless link and the second wireless link and an end-time of a replicated transmissions on the first wireless link is not required to be aligned with an end-time of a replicated transmission on the second wireless link.

61. The method according to claim 49, wherein the announcement of the replicated transmissions comprises a first indicator indicating usage of replication for transmission of data.

62. The method according to claim 49, wherein the announcement of the replicated transmissions comprises a second indicator indicating whether an upcoming replicated transmission corresponds to new data.

63. The method according to claim 49, wherein the wireless communication device is one of an access point of the wireless communication system and a wireless station, and wherein the further wireless communication device is the other one of the access point and the wireless station.

64. A method of controlling wireless transmissions in a wireless communication system, the method comprising:
a wireless communication device maintaining a first wireless link and a second wireless link to a further wireless communication device, the first wireless link and the second wireless link being based on different frequency channels;
the wireless communication device communicating, between the wireless communication device and the further wireless communication device, an announcement of replicated transmissions of data on the first wireless link and the second wireless link;
the wireless communication device receiving at least one of the replicated transmissions of the data; and
based on the announcement of the replicated transmissions of the data, the wireless communication device sending an acknowledgement of successful reception of the data on only one of the first wireless link or the second wireless link.

65. The method according to claim 64, comprising the wireless communication device receiving the announcement of the replicated transmissions from the further wireless communication device.

66. The method according to claim 64, comprising the wireless communication device sending the announcement of the replicated transmissions to the further wireless communication device.

67. A wireless communication device for operation in a wireless communication system, the wireless communication device comprising:
interface circuitry configured to maintain a first wireless link and a second wireless link to a further wireless communication device, the first wireless link and the second wireless link being based on different frequency channels; and
processing circuitry configured to use the interface circuitry to:
communicate, between the wireless communication device and the further wireless communication device, an announcement of replicated transmissions of data on the first wireless link and the second wireless link;
send the replicated transmissions of data on the first wireless link and the second wireless link; and
based on the announcement of the replicated transmissions, expect an acknowledgement of successful reception of the data on only one of the first wireless link and the second wireless link.

68. A wireless communication device for operation in a wireless communication system, the wireless communication device comprising:
interface circuitry configured to maintain a first wireless link and a second wireless link to a further wireless communication device; and
processing circuitry configured to use the interface circuitry to:
communicate, between the wireless communication device and the further wireless communication device, an announcement of replicated transmissions of data on the first wireless link and the second wireless link;
receive at least one of the replicated transmissions of the data; and
based on the announcement of the replicated transmissions of the data, send an acknowledgement of successful reception of the data on only one of the first wireless link or the second wireless link.
